(19) United States
(12) Patent Application Publication
(10) Pub. No.: US 2021/0394205 A1
(43) Pub. Date: Dec. 23, 2021

(54) FOGGING SPRAYER NOZZLE

(71) Applicant: Bojan SIMENDIC, Highland, MD (US)

(72) Inventor: Bojan SIMENDIC, Highland, MD (US)

(21) Appl. No.: 17/346,408

(22) Filed: Jun. 14, 2021

Related U.S. Application Data
(60) Provisional application No. 63/040,449, filed on Jun. 17, 2020.

(51) Int. Cl. B05B 3/04

(52) U.S. Cl. CPC B05B 3/0486

(57) ABSTRACT

Various embodiments include a fogging sprayer nozzle that includes a nozzle base and an outer cap. The nozzle base includes an inner passage extending along an axial extent of the nozzle base. The inner passage may be configured to allow a first fluid to pass through the nozzle base from a proximal base aperture in a proximal end of the nozzle base to a distal base aperture in a distal end of the nozzle base. The nozzle base may include a plurality of fins radially extending outwardly and spiraling along the axial extent of the nozzle base. The outer cap includes an inner chamber configured to receive and surround at least a portion of the nozzle base seated therein. The outer cap includes a proximal cap aperture in a proximal end of the outer cap and a distal cap aperture in a distal end of the outer cap. The nozzle base may be received through the proximal cap aperture. A second fluid may be configured to flow inside the inner chamber and between the plurality of fins from the proximal cap aperture toward the distal cap aperture.

### PRIORITY

This application claims the benefit of priority to U.S. Provisional Patent Application No. 63/040,449 entitled “Fogging Sprayer Nozzle” filed Jun. 17, 2020, the entire contents of which are hereby incorporated by reference for all purposes.

### BACKGROUND

Conventional paint and chemical sprayers emit a conical and/or fan-shaped spray pattern that is useful for coating a relatively small region in the direction in which the sprayer is pointed. Such sprayers do not generally disperse a main fluid in a broad and long reaching cloud formation.

### SUMMARY

Various embodiments include a fogging sprayer nozzle that includes a nozzle base and an outer cap. The nozzle base includes an inner passage extending along an axial extent of the nozzle base. The inner passage may be configured to allow a first fluid to pass through the nozzle base from a proximal base aperture in a proximal end of the nozzle base to a distal base aperture in a distal end of the nozzle base. The nozzle base may include a plurality of fins radially extending outwardly and spiraling along the axial extent of the nozzle base. The outer cap includes an inner chamber configured to receive and surround at least a portion of the nozzle base seated therein. The outer cap includes a proximal cap aperture in a proximal end of the outer cap and a distal cap aperture in a distal end of the outer cap. The nozzle base may be received through the proximal cap aperture. A second fluid may be configured to flow inside the inner chamber and between the plurality of fins from the proximal cap aperture toward the distal cap aperture.

In various embodiments, at least one of the plurality of fins includes a greater thickness at a distal portion thereof Additionally, or alternatively, a distal portion of at least one of the plurality of fins includes an airfoil-type cross-section.

Various embodiments further include methods of making fogging sprayer nozzle as summarized above.

### BRIEF DESCRIPTION OF THE DRAWINGS

The accompanying drawings, which are incorporated herein and constitute part of this specification, illustrate example aspects of various embodiments, and together with the general description given above and the detailed description given below, serve to explain the features of the claims.

FIG. 1 is an isometric exploded view of a fogging sprayer nozzle assembly, including a nozzle base and an outer cap, according to various embodiments.

FIGS. 2A-2E are partially translucent front isometric, rear isometric, side, rear, and front views, respectively, of an assembled fogging sprayer nozzle, according to various embodiments.

FIGS. 3A-3C are rear, front and side views, respectively, of the nozzle base according to various embodiments.

FIGS. 4A-4E are isometric-rear, side, side-section, rear, and front views, respectively, of the outer cap according to various embodiments.

FIGS. 5A-5F are various views of a sprayer, in various states of assembly, with a fogging sprayer nozzle in accordance with various embodiments.

### DETAILED DESCRIPTION

Various embodiments described herein relate to a nozzle for a sprayer that disperses a main fluid in a cloud formation that disperses the main fluid broadly and further than conventional sprayer nozzles. The nozzle may be used in many applications, such as for a fogging type spraying. The sprayer may include a nozzle base and an outer cap. The nozzle base may have an inner passage extending along an axial extent of the nozzle base. The inner passage may be configured to allow a first fluid to pass through the nozzle base from a proximal base aperture in a proximal end of the nozzle base to a distal base aperture in a distal end of the nozzle base. The nozzle base may also include a plurality of fins radially extending outwardly and spiraling along the axial extent of the nozzle base. The outer cap may have an inner chamber configured to receive and surround at least a portion of the nozzle base seated therein. The outer cap may include a proximal cap aperture in a proximal end of the outer cap and a distal cap aperture in a distal end of the outer cap. The nozzle base may be received through the proximal cap aperture. Also, a second fluid may be configured to flow inside the inner chamber and between the plurality of fins from the proximal cap aperture toward the distal cap aperture.

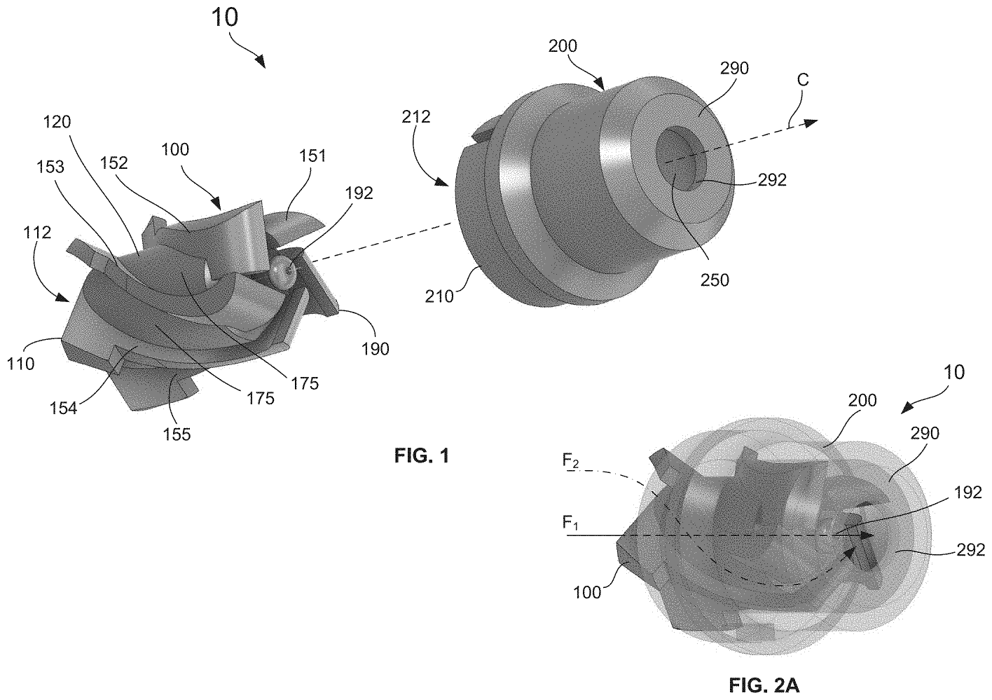

FIG. 1 illustrates an exploded view of a fogging sprayer nozzle 10, including a nozzle base 100 and an outer cap 200, according to various embodiments. A distal end 190 of the nozzle base 100 is configured to be inserted, along a common central axis C, inside a proximal cap aperture 212 in a proximal end 210 of the outer cap 200. Once assembled and in use, the fogging sprayer nozzle 10 is configured to mix two fluids (i.e., liquids and/or gases) and project them into a fog, similar to fogging devices used to apply insecticides. One fluid (i.e., a first fluid) may be the active chemical, mixture, or other fluid substance being dispersed by another fluid (i.e., a second fluid), such as air or another gas.

The nozzle base 100 may have an inner passage extending along an axial extent thereof The inner passage may be configured to allow the first fluid to flow through the nozzle base 100, from a proximal base aperture 112 in a proximal end 110 of the nozzle base 100 to a distal base aperture 192 in the distal end 190 of the nozzle base 100. The nozzle base 100 includes a plurality of fins 151, 152, 153, 154, 155 radially extending outwardly and spiraling along the axial extent of the nozzle base 100. Between each of the plurality of fins 151, 152, 153, 154, 155 a generally cylindrical outer base-surface 120 of the nozzle base 100, together with the fins 151, 152, 153, 154, 155, forms a spiral channel 175 between each adjacent pair of fins 151, 152, 153, 154, 155.

The outer cap 200 includes an inner chamber 250 that is configured to receive and surround at least a portion of the nozzle base 100 seated therein. The nozzle base 100 may be inserted into a proximal cap aperture 212 in a proximal end 210 of the outer cap 200. A distal cap aperture 292 in a distal end 290 of the outer cap 200 is configured to emit a fogging mixture of the first and second fluids.

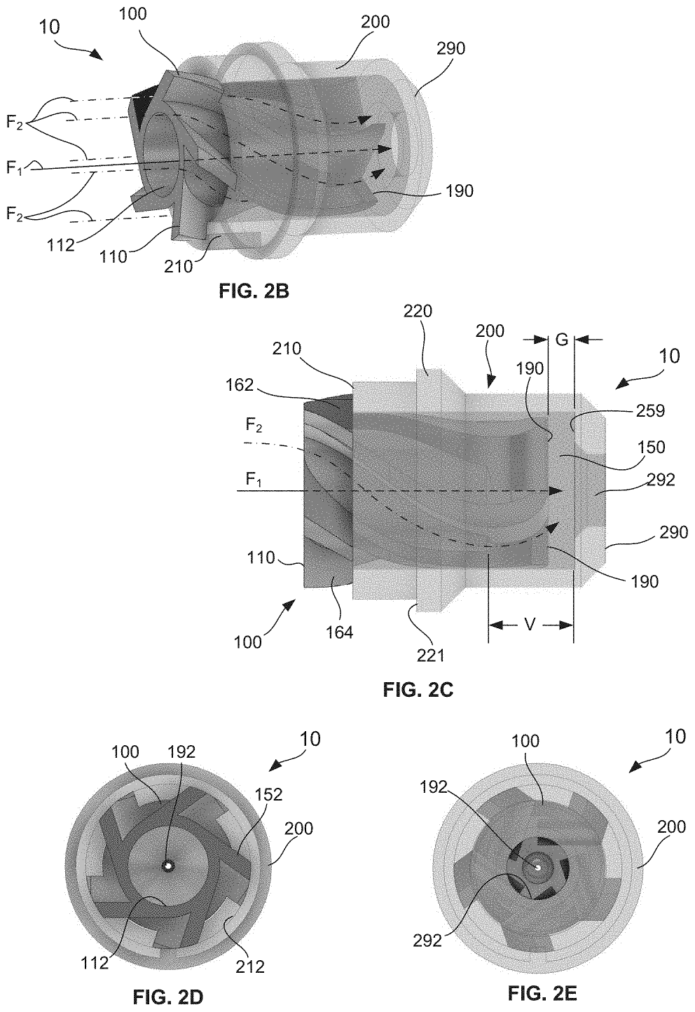

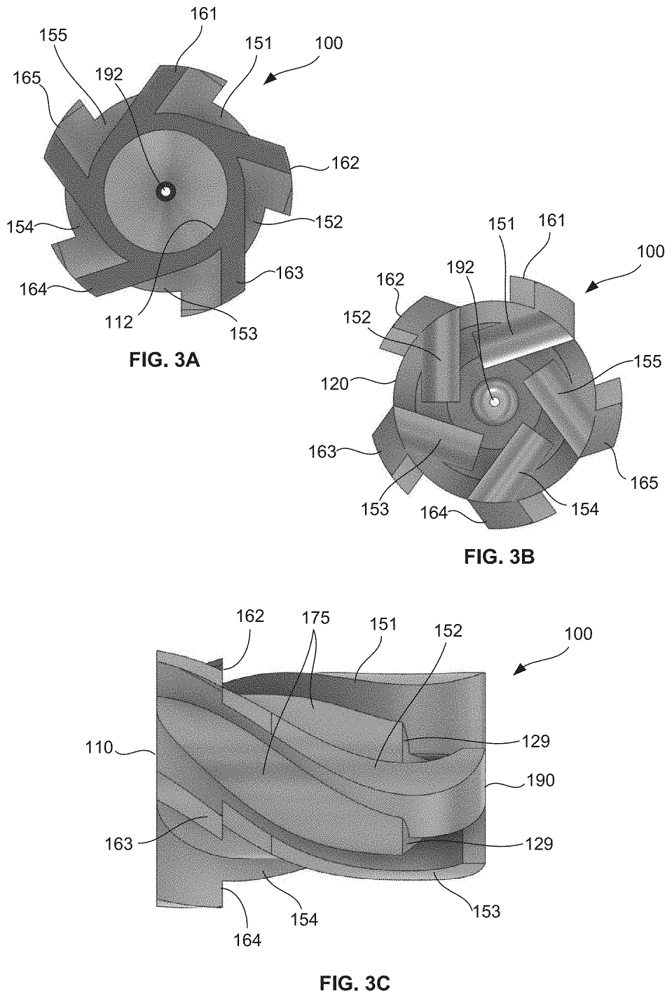

FIGS. 2A-2E illustrate the fogging sprayer nozzle 10 with the nozzle base fully seated in the outer cap 200, with the outer cap shown as translucent for illustrative purposes and ease of explanation. As particularly shown in FIG. 2C, when the nozzle base 100 is fully seated within the inner chamber 250 of the outer cap 200, a gap G is maintained between a distal end 259 of the inner chamber 250 and the distal end 190 of the nozzle base 100, which forms a mixing area 150. The distal end 190 of the nozzle base 100 is prevented from moving closer to the distal end 259 of the inner chamber 250 (i.e., closing the gap G) by radial protrusions 161, 162, 163, 164, 165 (see FIGS. 3A-3B) on the proximal portion of the fins 151, 152, 153, 154, 155. Each of the radial protrusions 161, 162, 163, 164, 165 extends radially outwardly further than a distal portion of the fin from which it protrudes. In this way, when the nozzle base 100 is fully seated inside the outer cap 200, the radial protrusions 161, 162, 163, 164, 165 remain outside the outer cap 200. Optionally, not all of the fins 151, 152, 153, 154, 155 need to include a radial protrusion 161, 162, 163, 164, 165.

A first fluid flow path Fi (illustrated with solid lines outside the fogging sprayer nozzle 10 and dotted lines inside) extends along the common central axis C from the proximal base aperture 112 and through the distal base aperture 192, into the mixing area 150, and eventually out the distal cap aperture 292. In this way, the mixing area 150 receives a generally linear flow of the first fluid F₁ from the distal base aperture 192. In contrast, a series of second fluid flow paths F₂ (illustrated with phantom lines) extend between each of the adjacent pairs of fins 151, 152, 153, 154, 155. The second fluid flow paths F₂ start at a proximal end 110 of the nozzle base (outside the outer cap 200) in a proximal portion of the spiral channels 175, continue through the remainder of the spiral channels 175 inside the inner chamber 250, and also flow into the mixing area 150. The spiral flow pattern imparted on the second fluid F₂ by the spiral channels 175 promotes a circular flow in the mixing area 150 that is configured to mix the first and second fluids F₁, F₂ therein. After mixing in the mixing area, the first and second fluids F₁, F₂ get expelled from the distal cap aperture 292 as a fogging spray.

As particularly shown in FIG. 2C, a distal end of the fins 151, 152, 153, 154, 155 may extend axially in the distal direction further than the generally cylindrical outer base-surface (e.g., 120) of the nozzle base 100. In this way, the nozzle base 100 may have a distally facing surface 129 that will be further offset from the distal end 259 of the inner chamber 250 than the fins 151, 152, 153, 154, 155. In this way, a spacing V between the distally facing surface 129 and the distal end 259 of the inner chamber 250 may be substantially greater than the gap G. Making the generally cylindrical outer base-surface shorter than the fins 151, 152, 153, 154, 155 not only increases the volume of the mixing area 150 but also allows the distal ends of the fins 151, 152, 153, 154, 155 to act as mixing paddles in the mixing area 150.

FIGS. 3A-3C illustrate rear (proximal side), front (distal side), and side views, respectively, of the nozzle base 100 according to various embodiments. As particularly shown in FIG. 3C, each of the radial protrusions 161, 162, 163, 164, 165 extends radially outwardly further than a distal portion of the respective fin 151, 152, 153, 154, 155 from which it protrudes. Thus, each of the radial protrusions 161, 162, 163, 164, 165 includes a distally facing edge that is configured to engage the proximal end 210 of the outer cap 200.

As additionally shown in FIG. 3C, the fins 151, 152, 153, 154, 155 may gradually widen, with a proximal end 110 being narrower than a distal end 190. Providing thicker distal portions on the fins 151, 152, 153, 154, 155 may provide a compression for that increases a mixing speed of the second fluid. Optionally, the distal portion of the fins 151, 152, 153, 154, 155 may even have and airfoil-type cross-section, which may encourage the nozzle base 100 to rotate as the second fluid creates lift-forces on the airfoil-type surfaces.

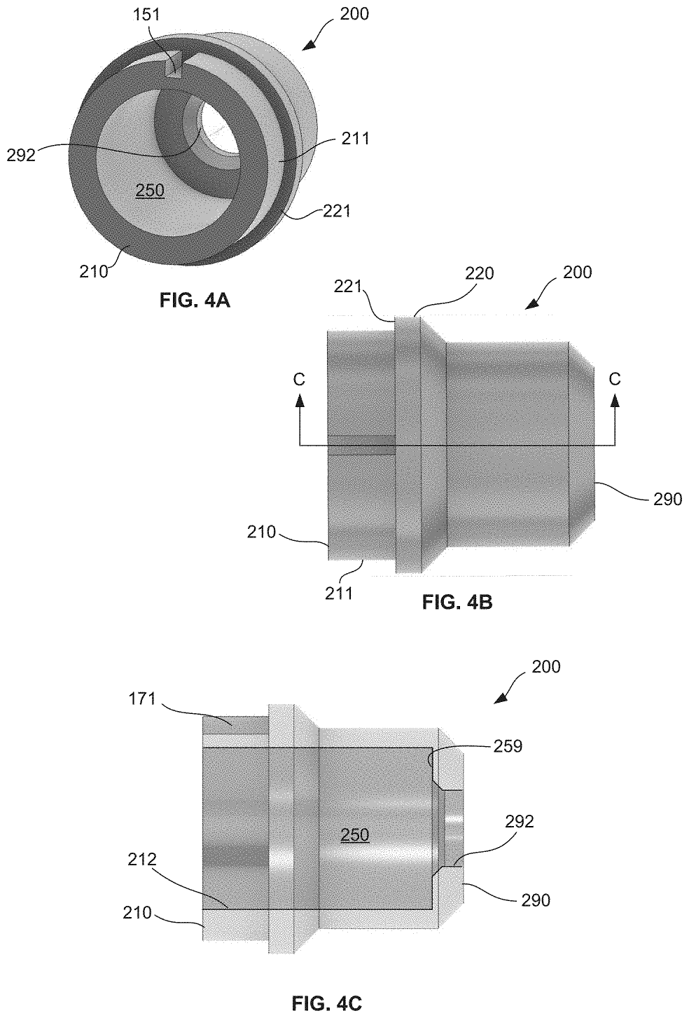

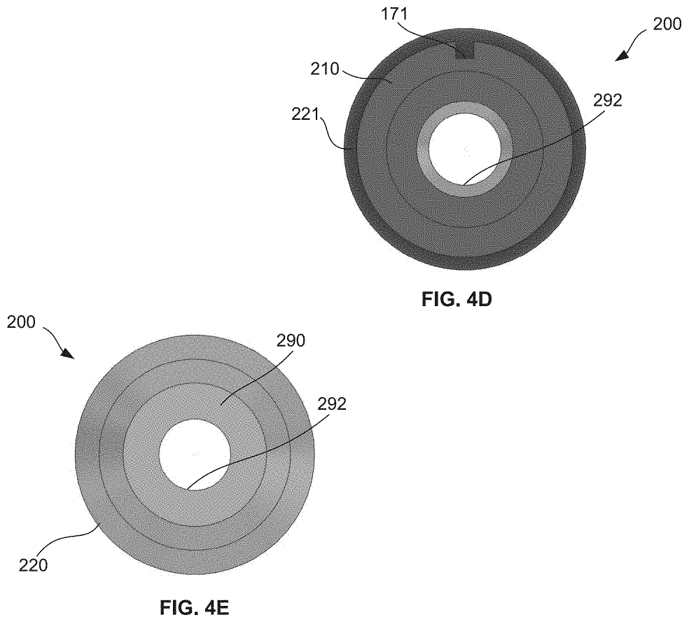

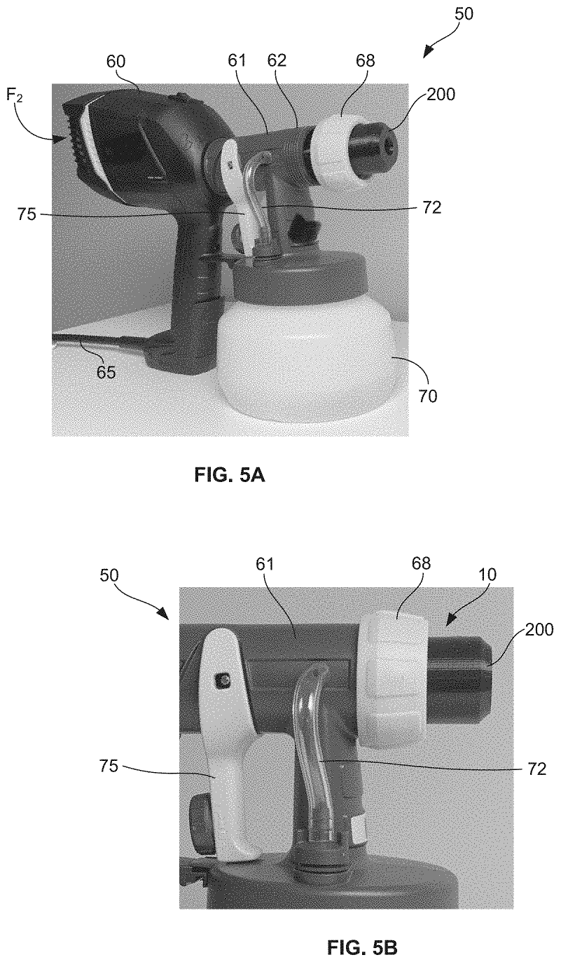

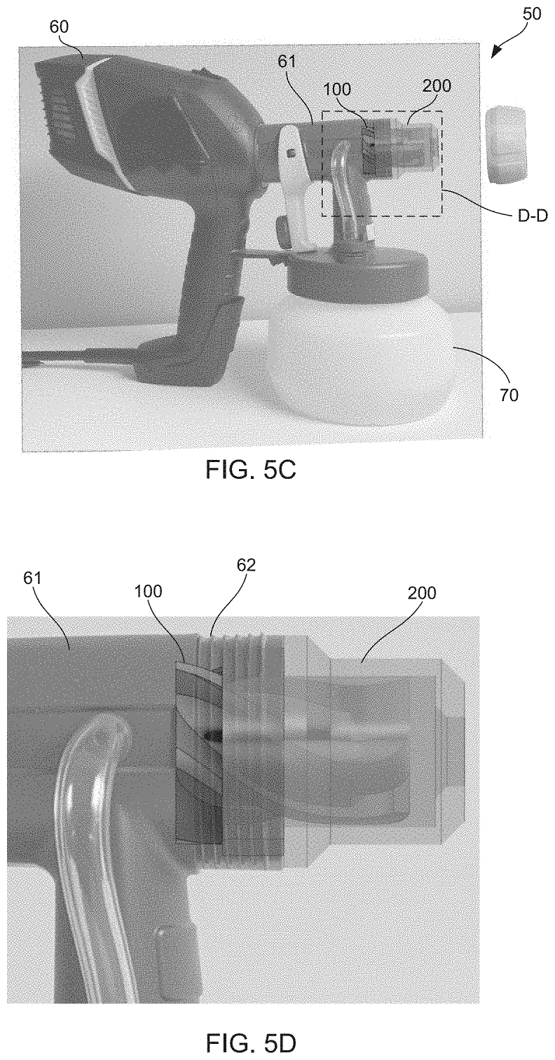

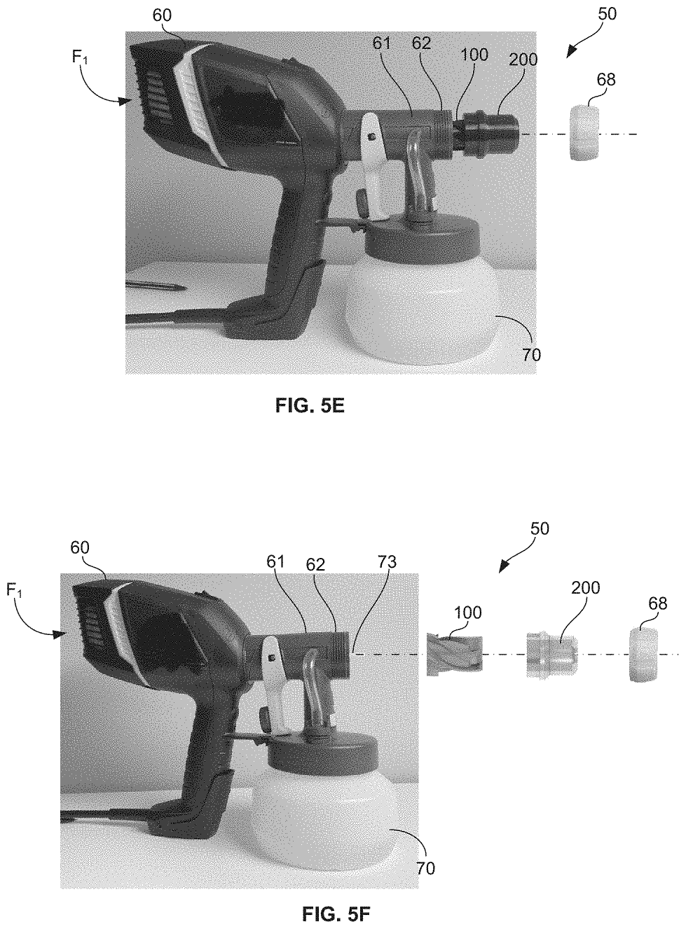

FIGS. 4A-4E illustrate rear isometric (from proximal side), side, side-section, rear, and front views, respectively, of the outer cap 200 according to various embodiments. The outer cap 200 may include an outer collar 220 that flare-out radially further than other portions of the outer cap 200. The outer collar 220 may be configured to receive a locking cap (See, 68 in FIGS. 5A-5F). In addition, a proximally facing surface 221 of the outer collar 220 may be configured to engage an end surface of a receiving aperture on a sprayer. In this way, a cylindrical base 211 of the outer cap 200 is configured to be received inside a barrel of the sprayer (see, FIG. 5C-5D), while the outer collar 220 acts as a limiting stop (see, FIGS. 5A-5F). In addition, a proximal outer surface of the outer cap 200 may have a key slot 171 configured to mate with a key element in the mating cylinder on the sprayer with which the fogging sprayer nozzle is configured to work. The key slot 171 may restrict the outer cap 200 from rotating, once mounted on the sprayer. FIG. 4C is a section view at C-C in FIG. 4B, which cuts through the key slot 171.

FIGS. 5A-5F illustrate a sprayer assembly 50, which includes a sprayer body 60 and a fogging sprayer nozzle 10, in various states of assembly, in accordance with various embodiments.

In FIGS. 5A and 5B, the sprayer assembly 50 is fully assembled. As shown, the sprayer assembly 50 may include a sprayer body 60, which is configured to hold motors, fans, pumps, and other elements for drawing-in and pressuring a mixture of fluids to spray. The internal motor may be powered by a corded power supply 65, a battery, or a combination thereof In particular, an internal motor may be used to draw-in air, which may be used as a second fluid F₂ (i.e., a dispersion fluid). The second fluid F₂ is then directed through a barrel 61 of the sprayer, toward the fogging sprayer nozzle 10. The sprayer body 60 may also include a reservoir 70, for holding a first fluid F₁ (i.e., a working fluid). The working fluid may be pulled out of the reservoir 70, by negative pressure, through an external feeder tube 72, for injecting the working fluid into an internal feeder tube (e.g., 73 in FIG. 5F) that feeds directly into the internal passage of the nozzle base (e.g., 100) of the fogging sprayer nozzle 10. A trigger handle 75 may be included, which opens and closes a valve that controls the flow of fluids from the sprayer assembly 50.

The sprayer assembly 50 may include a locking cap 68, which is removably secured to a threaded portion 62 of the barrel 61. The locking cap 68 may include internal threading that mates with the threaded portion 62. By removing the locking cap 68, a nozzle may be mounted on and/or removed from the barrel 61 of the sprayer assembly 50, such as for cleaning or changing to a different nozzle. FIG. 5C shows the locking cap 68, removed from the barrel 61, which frees the nozzle base 100 and outer cap 200 for removal from the sprayer assembly 50.

FIG. 5D is a relief view at D-D in FIG. 5C. As shown in FIG. 5D, the cylindrical base (e.g., 211) of the outer cap 200 may sit inside the barrel 61 of the sprayer assembly 50. Also, shown is how the proximal portion of the nozzle base 100 extends further into the inside of the barrel 61, than the outer cap 200. The further extending portion of the nozzle base 100 provides an added length to the spiral channels 175, which may promote better circular flow of the second fluid for mixing with the first fluid in the mixing area.

FIG. 5E illustrates the nozzle base 100 and outer cap 200 being separated from the sprayer assembly 50, like the locking cap 68.

FIG. 5F illustrates the nozzle base 100 and outer cap 200 fully separated from the sprayer assembly 50 and each other.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the claims not intended to be limited to the embodiments shown herein but is to be accorded the widest scope consistent with the language of the following claims and the principles and novel features disclosed herein.

What is claimed is:

1. A fogging sprayer nozzle, comprising:
a nozzle base having an inner passage extending along an axial extent of the nozzle base, wherein the inner passage is configured to allow a first fluid to pass through the nozzle base from a proximal base aperture in a proximal end of the nozzle base to a distal base aperture in a distal end of the nozzle base, wherein the nozzle base includes a plurality of fins radially extending outwardly and spiraling along the axial extent of the nozzle base; and
an outer cap having an inner chamber configured to receive and surround at least a portion of the nozzle base seated therein, wherein the outer cap includes a proximal cap aperture in a proximal end of the outer cap and a distal cap aperture in a distal end of the outer cap, wherein the nozzle base is received through the proximal cap aperture, wherein a second fluid is configured to flow inside the inner chamber and between the plurality of fins from the proximal cap aperture toward the distal cap aperture.

2. The fogging sprayer nozzle of claim 1, wherein at least one of the plurality of fins includes a radial protrusion extending radially outwardly further than a distal portion of the respective one of at least one of the plurality of fins, wherein the radial protrusion remains outside the outer cap when the nozzle base is fully seated inside the outer cap.

3. The fogging sprayer nozzle of claim 2, wherein a distally facing edge of the radial protrusion engages the proximal end of the outer cap.

4. The fogging sprayer nozzle of claim 1, wherein a gap is formed between a distal end of the inner chamber and the distal end of the nozzle base forming a mixing area when the nozzle base is fully seated within the inner chamber, wherein the first and second fluids are forced to mix in the mixing area.

5. The fogging sprayer nozzle of claim 1, wherein at least one of the plurality of fins includes a greater thickness at a distal portion thereof

6. The fogging sprayer nozzle of claim 1, wherein a distal portion of at least one of the plurality of fins includes an airfoil-type cross-section.
